(19) United States
(12) Patent Application Publication
(10) Pub. No.: US 2011/0129050 A1
(43) Pub. Date: Jun. 2, 2011

(54) Method and Device for Identification of Explosives by means of Neutron Bombardment

(76) Inventors: Jürgen Walter Leonhardt, Berlin (DE); Hetmut Wolfgang Wurzer, Dresden (DE); Axel Thomas Friedrich Küster, Berlin (DE); Klau-Peter Otto Francke, Berlin (DE)

(21) Appl. No.: 12/958,360

(22) Filed: Dec. 1, 2010

(30) Foreign Application Priority Data
Dec. 2, 2009 (DE) 10 2009 057 276.7

(51) Int. Cl. G21G 1/06

(52) U.S. Cl. 376/159

(57) ABSTRACT

A method and device for explosives identification bombards a sample with neutrons the energy of which is to the positron activation energy of nitrogen and to the required energy for a neutron proton nuclear reaction of neutrons with ¹⁶O to ¹⁶N. Electron positron annihilation radiation emitted by the sample due to the neutron bombardment is then detected as a function of time. The respective concentration and the concentration ratio of oxygen and nitrogen in the sample is determined from the time dependency of the annihilation radiation, and the explosive is identified by the comparison of the concentration ratios of the specific concentrations of oxygen and nitrogen with the corresponding substance ratios of known explosives. By radiation with neutrons at the same time radionuclides ¹³N are created from the nitrogen contained and ¹⁶N from the oxygen contained, the decay of which generates electron positron annihilation radiation with characteristic half-lives.

### CROSS REFERENCE TO RELATED APPLICATION

This application claims priority of DE 10 2009 057 276.7 filed Dec. 2, 2009 and is incorporated by reference herein.

### FIELD OF THE INVENTION

The present invention relates to a method and device for identification of explosives by means of bombardment of a sample with neutrons. In particular oxygen and nitrogen concentrations are determined in the sample.

### BACKGROUND ART

The analysis of pieces of luggage on airports or pallets in cargo service for explosives is for the public benefit. Current methods do not permit definite identification of such substances since the state of the art substantially does not permit any material information.

It is known that detection of explosives in pieces of luggage is best possible by determination of some typical elements such as N, O, C, H and their respective ratios N/O, N/C, O/C, O/H.

Their detection in containers requires the use of penetrating radiation. X-rays permit representation of a high-resolution density distribution but only provides indications on portions of lightweight elements by determining an effective ordinal number. Element determination is not possible.

Moreover, application of monoenergetic gamma radiation is known. This offers sometimes advantages compared with x-ray but it does not solve the problem. Neutron radiation, however, offers advantages since neutrons penetrate well also metals. Thermalisation of fast neutrons provides a signal proportional to the hydrogen content in the scattering medium. The scattering behaviour of rapid neutrons contains information characterising the matrix elements where the hydrogen atoms reside. With suitable detectors such as for example helium 3 or BF3 counting tubes thermal neutrons are detected. If helium 3 counting tubes are sheathed with cadmium, they detect only rapid neutrons. If subsequently ratios are formed from the figures of thermal and rapid neutrons, explosives can be identified as a group in forth and back scatter geometry.

Moreover it is known to carry out an element contents' determination for hidden explosives by using inelastic scattering of rapid, preferably 14-MeV neutrons in order to generate characteristic, prompt gamma radiation for H, C, N and O. Such characteristic gamma radiation must be captured by a high-resolution spectrometric detector which is often cooled with nitrogen. Due to long measuring times such measuring methods are only conditionally suitable for rapid scanning of a sample. The detection mass of explosives amounts to some 10 kgs. The measuring technique to be used is complex and expensive. Achievable times are 10 minutes and more.

Moreover, an element contents' determination of a sample is possible when using γ, n reactions for C, N, O. Such a method is described in DE 41 03 448 A1. It requires availability of highly energetic photons as from 10 MeV which are provided by means of electron accelerator with bremsstrahl target. Identification occurs by determination of the time dependency of the integral intensity of radiation of the 511 keV annihilation radiation resulting directly from the respective positron emitter, and determination of different half-lives. The reactions for formation of the positron emitters occurring at the γ energies 10.55, 15.67, 18.72 MeV are ¹⁴N(γ, n)¹³N, ¹⁶O(γ, n)¹⁵O and ¹²C(γ, n)¹¹C. The corresponding half-lives of the annihilation radiation from the positron emitters are for ¹³N nitrogen 9.9 min, for ¹⁵O oxygen 2.03 min and for ¹¹C carbon 20.38 min. Each annihilation radiation has its typical decay behaviour corresponding to the half-life and permits identification of the ratios O/N, C/N. But provision of high-energy photons in the range of 10-18 MeV requires an electron accelerator which is not very suitable for inspection purposes due to its dimension. Disadvantage of the method and the corresponding device is thus the limitation of use of electron accelerators with performance characteristics of 25 MeV and beam amperages of 100 μA. Analysis time of radiation is some minutes.

It is therefore the object of the present invention to provide a method for identification of explosives overcoming the disadvantages of prior art. In particular it is the object of the present invention to provide a method for identification of explosives permitting rapid determination of explosives. Therefore, a method and device for identification of explosives by means of bombardment with rapid neutrons is proposed, at first comprising the step of bombardment of a sample with neutrons the energy of which is greater or equal to the positron activation energy of nitrogen and greater or equal to the required energy for a neutron proton nuclear reaction of neutrons with ¹⁶O to ¹⁶N. Moreover, subsequently the electron positron annihilation radiation emitted by the sample due to the neutron bombardment is detected as a function of time. Then the respective concentration and/or the concentration ratio of oxygen and nitrogen in the sample is determined from the time dependency of the annihilation radiation, and the explosive is identified by means of comparison of the concentration ratios of the specified concentrations of oxygen and nitrogen with the corresponding substance ratios of known explosives.

By radiation with neutrons at the same time radionuclides ¹³N are created from the nitrogen contained and ¹⁶N from the oxygen contained, the decay of which generates electron positron annihilation radiation with characteristic half-lives.

The inventive method thus advantageously permits rapid determination of the nitrogen and oxygen contents of a test sample which is irradiated by means of rapid, preferably 14 MeV, neutrons. In this process gamma radiation of an energy of 511 kiloelectron volt is created which is measured as a time function. Application of neutrons advantageously permits the use of further reactions apart from the creation of positron emitters. Thus, the neutrons can interact with protons of a nucleus. This is utilised in order to generate ¹⁶N from ¹⁶O by bombardment with neutrons which rapidly decays radioactively thus creating electron positron annihilation radiation again in the process.

The annihilation radiation is created by generation of a ¹³N nitrogen positron emitter as a result of neutron bombardment, emission of positrons, electron positron pair formation and annihilation of the electron positron pairs by emitting two gamma quantums. Moreover, annihilation radiation may occur by generation of radioactive ¹⁶N nitrogen by an n, p nuclear reaction of the neutrons with ¹⁶O, subsequent radioactive decay of ¹⁶N and the formation of a first gamma radiation, electron positron pair formation by the first gamma radiation, and annihilation of the electron positron pairs by emitting two gamma quantums.

Thus, two different radionuclides are formed with neutrons at a specific energy, namely ¹³N out of nitrogen and ¹⁶N out of oxygen, the annihilation radiation of which in the form of 511 keV gamma quantums has a characteristic half-life.

More preferred is the neutron energy at 14 MeV which are created by the D, T reaction. Corresponding neutron sources are portable and commercially available. The electron positron annihilation radiation has a characteristic energy of 511 keV. Radiation only with this energy is measured which simplifies the test setup and increases precision. Detection of annihilation radiation occurs preferably by means of a scintillation crystal with MCA.

Determination of the concentration from the time dependency of the annihilation radiation preferably occurs by taking into account the characteristic half-lives and/or the decay constants of the respective annihilation radiation with the annihilation radiation due to the ¹⁶N decay having a first characteristic half-life and/or decay constant, and the annihilation radiation due to the ¹³N positron emitter having a second characteristic half-life and/or decay constant.

Determination of the oxygen concentration occurs within the first half-life and subsequently determination of the nitrogen concentration is made. As soon as after a rapid decline of the graph to be attributed to the oxygen concentration another, slower decay behaviour occurs, determination of the oxygen concentration can be made.

The first characteristic half-life for the 511 keV quantum from the oxygen portion is approx. 7 seconds and the second characteristic half-life for nitrogen approx. 600 seconds. Thus, measurement can advantageously occur within seconds since already after a few seconds the nitrogen portion is dominant.

The respective concentration of oxygen and nitrogen may occur by extrapolation of the time dependency measured of the respective annihilation radiation of the corresponding elements for the point in time t=0 s.

For identification of the explosive in addition the decay behaviour of the annihilation graph with the greater half-life can be used, hence that of nitrogen. Advantageously this decay behaviour is characteristic already for many explosives. Advantageously the method further comprises the step of location of the annihilation by coincident detection of the two gamma quantums from the corresponding annihilation which are emitted from the sample simultaneously into different directions. The location of the annihilation can be made by means of a positron emission tomography detector.

Preferably a neutron source intensity of 10¹⁰ neutrons/s is used which permits a rapid measurement in the range of seconds.

Location of the explosive can moreover be completed and evaluated in addition by the information of an additional X-ray apparatus. The X-ray apparatus only provides information on density distribution with an effective ordinal number but has a high precision of site.

Moreover, the method can be completed by a detection system based upon an ion mobility spectrometer (IMS) in order to detect highly volatile explosives which do not contain nitrogen. Such a detection system is a multi-gas detector for highly sensitive detection of volatile components.

Accordingly, a device for explosives' identification is proposed comprising a neutron source generating neutron energies which is greater or equal to the positron activation energy of nitrogen and greater or equal to the required energy for a neutron proton nuclear reaction of neutrons with ¹⁶O to ¹⁶N, a scintillation detector for radiation measurement or a PET detector comprising each a detector unit on opposite sides of the sample.

### BRIEF DESCRIPTION OF THE DRAWINGS

Embodiments of the invention are shown in the drawings and are explained more in detail in the following description where

FIG. 1 is the schematic decay behaviour of the annihilation radiation of a sample after radiation with inventive neutrons,

FIG. 2 is the decay behaviour of the 511 keV lines measured for TNT and sugar after radiation of the sample with neutrons of energy 14 MeV,

FIG. 3 is the plan view (a) and side view (b) of an inventive device with a scintillation detector

FIG. 4 is the plan view (a) and side view (b) of an inventive device with a PET detector

### DETAILED DESCRIPTION OF THE DRAWINGS

The inventive method permits rapid determination of the nitrogen and oxygen content of a test sample which is irradiated by means of rapid, preferably 14 MeV neutrons. In this process gamma radiation of an energy of 511 kiloelectron volt is generated which is measured as a time function.

The 511 keV radiation, also called annihilation radiation, is generated in the process in two ways after radiation with rapid neutrons.

One method utilises occurrence of the positron emitter ¹³N with a half-life of 9.9 minutes. The positron emitted of this radionuclide forms a pair with a shell electron of the sample which is destroyed by emitting two diametrically opposed 511 keV gamma quantums. This process provides the nitrogen portion of the annihilation signal measured.

The second method involves oxygen for formation of 511 keV quantums. By the inventive radiation with neutrons, preferably but non limitative with an energy of 14 MeV in an n, p nuclear reaction with ¹⁶O the radioactive nitrogen ¹⁶N is generated which by emitting β⁻ particles and high-energy quantums of energy of 6.13 MeV decays in only approx. 7 seconds. The high-energy quantum creates in the nuclear field or near shell electrons a pair composed of positron and electron. If this pair is destroyed, two opposite 511 keV gamma quantums are generated again which form the rapidly decaying portion in the time function of the measuring signal and are proportional to the oxygen content of the sample.

Thus, the temporal decline of the 511 keV annihilation radiation is used as a measured quantity. The signal (counts per second) is generated as follows in other words :

In a first step the sample is bombarded with neutrons which have sufficient energy so that not only the ¹³N positron emitter can be generated but also an n, p nuclear reaction of ¹⁶O with the neutrons at ¹⁶N takes place. Preferably the D, T reaction for generation of 14 MeV neutrons is used. Such a neutron generator can be used portably and can be switched off. If its source intensity is 10⁸ neutrons/s, approx. 2 to 5 minutes are necessary for approx. 100 g TNT. The radiation time decreases proportionally with increasing source intensity. Commercial neutron generators with 10¹⁰n/s permit times below 10 s. Thus measurement occurs far more rapidly compared with prior art. Then, annihilation radiation is measured in situ and after a rapid transport of the irradiated sample in measuring position before a scintillation crystal of large volume, preferably with MCA. Only 511 keV gamma radiation is recorded. Thus, the measuring conditions are improved compared with prior art. A graph as a function of time occurs the first portion of which, which lasts only a few minutes, dominates due to the rapid decay of ¹⁶N and which is proportional to the oxygen concentration. After approx. 10 seconds the slow decay of the ¹³N nitrogen with a half-life of T_{1/2}≈9.9 minutes becomes dominant. The signal is then proportional to the nitrogen content of the sample.

It is pointed out that for most substances the nitrogen content is entirely omitted such as for example for creams, alcohol, water, soap, aftershave, toothpaste etc. Thus the measuring conditions for explosives improve extremely.

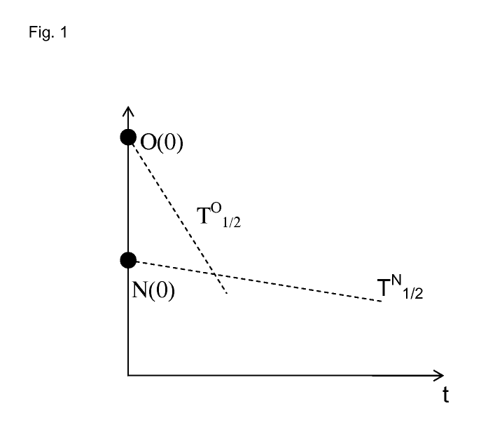

From the decline of the graph the oxygen is identified by decay constant and/or half-life. By extrapolation of the graph to the measuring time t=0 s one obtains the oxygen concentration. The lower decline is dominated by the half-life of the oxygen. Extrapolation to t=0 s produces the N portion. This is schematically shown in FIG. 1. The oxygen portion declines far more rapidly than the nitrogen portion. Since radiation is proportional to the concentration of the respective elements, from the axis portion to time t=0 s the respective concentration can be determined.

In a last step the concentration ratio oxygen to nitrogen is then formed and compared with the known values of the different types of explosives. Thus the explosive can be identified.

The comparison can be carried out from theoretical values and the measured values taking into account the effective cross sections of the corresponding elements for neutrons. But preferably the known explosives are measured according to the method and the empirical data are saved in a database. The comparison of empirical data permits a more simple determination of the explosive. Moreover, also the shape of the decay graphs can be compared.

A corresponding device comprises a neutron generator of the D, T type as well as a scintillation crystal of large volume with multichannel analyser which has set a measuring window on the gamma energy of 511 keV.

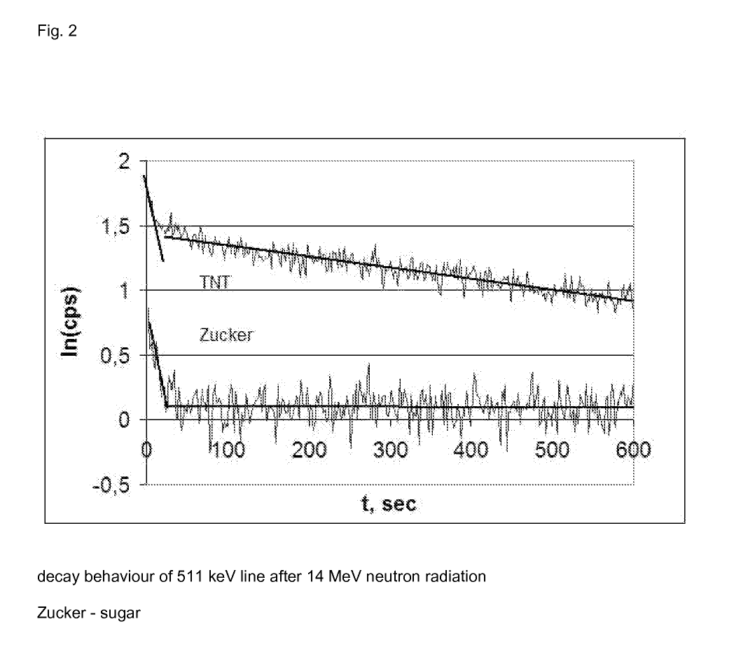

In FIG. 2 an actual graph corresponding to the inventive method is shown. On the one hand the TNT explosive and on the other hand sugar served as a sample. The different graph patterns are clearly visible. The rapid decline corresponds to the oxygen portion, the slow decline corresponds to the nitrogen portion. From the extrapolation to t=Os the corresponding concentrations are then determined again. Sugar does not have any nitrogen content, therefore no slowly declining portion of the graph exists. After decline of the oxygen graph only the noise dominates.

Thus, O(0)/N(0) and/or N(0)/O(0) serves for identification. Urea and ammonium nitrate have similar signatures but they are not typical, for example, of hand luggage in an airplane.

But the slowly declining plot alone is in particular also typical of all explosives. Hence, in addition the decay behaviour of the slow portion of the graph can be used for identification.

Measurement of the 511 keV line is made with NaJ crystals of large volume the geometry and counting efficiency of which are most suitable. Proportional counting tubes are likewise suitable. They can be used near the generator. Optimisation of the O/N ratios is made by selection of appropriate radiation times of the neutron generator which are kept variable.

The decline graph itself is likewise a typical fingerprint, its decline analysis is made automatically.

Finally, the data are compared with signatures and concentration ratios of all hazardous materials in an internal library which can be done in a computing unit.

By application of portable neutron generators with source intensities of 10¹⁰ n/s good measurement statistics are obtained when NaJ crystals of large volume are used, pulse times decrease to values below one minute.

Moreover, the method comprises an advantageous combination with location of the explosive in the sample, preferably by means of a positron emission tomography (PET) detector. Detectors for PET could also be realized in semiconductor technology but presently in all clinical PET a combination out of scintillation crystal and photomultiplier is used. In the case of clinical PET, radionuclides must be injected into the patient for detection.

In the present invention, however, these are formed by bombardment with the inventive neutrons, here ¹³N or ¹⁶N. If a positron created by decay of the radionuclides ¹³N or ¹⁶N, which are formed by bombardment of the sample with the inventive neutrons, hits an electron, both are annihilated. Two highly energetic photons (gamma radiation) are created of an energy of precisely 511 keV which move away from each other in an angle of almost 180°. This annihilation radiation can simultaneously, hence coincidentally, impinge upon two detectors permitting detection and simultaneously location of the positron emission. If two y quantums of an energy of 511 keV are detected at the same time with a typical time frame of the detection electronics of 4.5 to 15 nanoseconds, this is interpreted as a positron electron annihilation on the imagined line between the signal generating detectors. This is the so-called line of response (LOR) and/or coincidence line.

The energy of the annihilation radiation to be detected is with discretely 511 keV greater than the maximum energy of the X-ray spectrum used in X-ray diagnostics (up to 150 keV in computer tomography). Probability of interaction with matter is therefore comparably low.

By the use of PET detectors the method provides good possibilities of precise location.

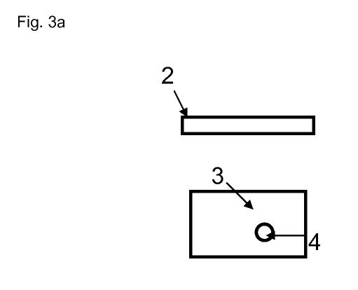

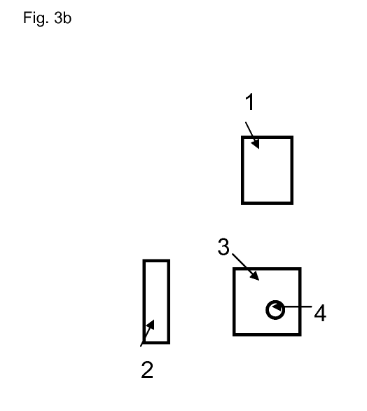

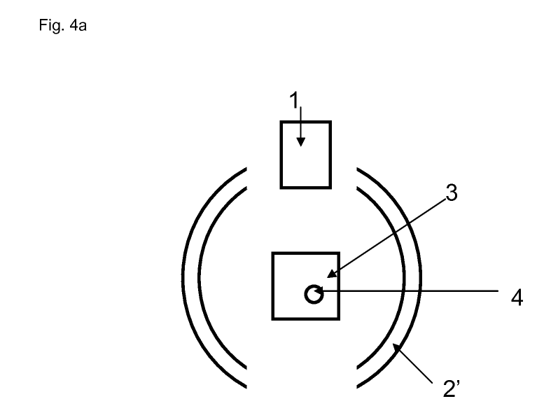

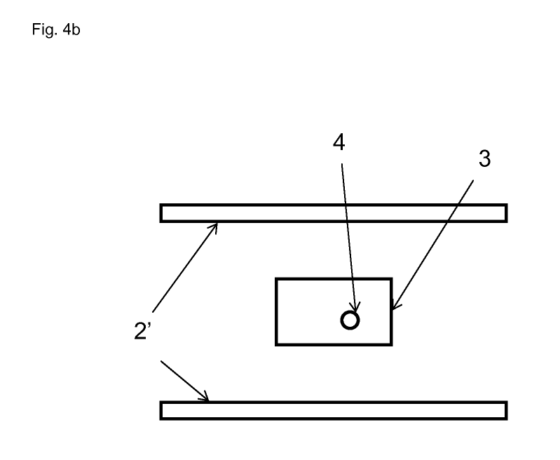

Corresponding arrangements for local detection of critical substances with N and/or O such as for example explosives for example in pieces of luggage are described in FIGS. 3 and 4 in two embodiments and comprise:
a neutron source 1 preferably emitting neutrons of an energy of 14 MeV,
an object 3 to be examined in which for example the explosive 4 is located and the radionuclides ¹³N and ¹⁶N occur by neutron bombardment; on decay of these radionuclides by annihilation the annihilation radiation to be detected is created at 511 keV, bi-directionally at an angle of 180°,
a scintillation crystal 2 with a measuring window at 511 keV (FIG. 3), or
a PET detector 2′ arranged with each a detector surface on opposite sides of the sample which coincidentally analyses the y radiation with an energy of 511 keV (FIG. 4).

Since the PET detector 2 also comprises a scintillation crystal, preferably either a scintillation crystal 2 (FIG. 3) or a PET detector 2′ (FIG. 4) is used.

The use can for example occur in the case of suspicion on pieces of luggage or containers in combination with an X-ray apparatus. The X-ray apparatus has a high precision of site. With it the neutron generator can be positioned precisely to the object to be examined.

Moreover, the positron emission in combination with the two-channel method with thermalised and rapid neutrons offers a clear delimitation from the substances with high hydrogen content such as H₂O, PE, paraffin or foodstuffs.

Other positron emitters such as ¹⁸F can be used for the identification for example of toothpaste (¹⁹F(n, 2n)¹⁸F, T_{1/2}=109 minutes).

The measuring method is also suitable for the detection of explosives in pallets, even if maskings with oils, waters etc. are used.

What is claimed is:

1. A method for the identification of explosives comprising the following steps:
bombardment of a sample with neutrons, the energy of which is greater or equal to the positron activation energy of nitrogen and greater or equal to the required energy for a neutron proton nuclear reaction of neutrons with ¹⁶O to ¹⁶N,
detection of an electron positron annihilation radiation emitted by the sample due to the neutron bombardment as a function of time,
determination of the respective concentration and the concentration ratio of oxygen and nitrogen in the sample from the time dependency of the annihilation radiation, and
identification of explosives by means of the comparison of the concentration ratios of the specific concentrations of oxygen and nitrogen with the corresponding substance ratios of known explosives.

2. A method according to claim 1, with the annihilation radiation occurring by :
generation of a ¹³N nitrogen positron emitter due to neutron bombardment,
emission of positrons,
electron positron pair formation,
annihilation of the electron positron pairs by emitting two gamma quantums.

3. A method according to claim 1, with the annihilation radiation occurring by:
creation of radioactive ¹⁶N nitrogen by an n, p nuclear reaction of the neutrons with ¹⁶O,
radioactive decay of ¹⁶N and formation of a first gamma radiation,
electron positron pair formation by the first gamma radiation,
annihilation of the electron positron pairs by emitting two gamma quantums.

4. A method according to claim 1, with neutron energy being at 14 MeV.

5. A method according to claim 1, with the annihilation radiation having an energy of 511 keV.

6. A method according to claim 1, with detection of the annihilation radiation taking place by means of a scintillation crystal.

7. A method according to claim 1, with determination of the concentration occurring from the time dependency of the annihilation radiation taking into account the characteristic half-lives and/or decay constants of the respective annihilation radiation, with the annihilation radiation due to the ¹⁶N decay having a first characteristic half-life and/or decay constant, and the annihilation radiation due to the ¹³N positron emitter having a second characteristic half-life and/or decay constant.

8. A method according to claim 7, with determination of the oxygen concentration occurring within the first half-life and subsequently determination of the nitrogen concentration occurring within the second half-life.

9. A method according to claim 7, with the first characteristic half-life being approx. 7 seconds and the second characteristic half-life being approx. 600 seconds.

10. A method according to claim 1, with the respective concentration of oxygen and nitrogen occurring by extrapolation of the measured time dependency of the respective annihilation radiation of the respective elements for the point in time t=0 s.

11. A method according to claim 7, with the decay behaviour of the annihilation graph with the greatest half-life being used in addition for identification of the explosive.

12. A method according to claim 1, further comprising the step of location of the annihilation by coincident detection of the two gamma quantums from annihilation emitted simultaneously from the sample into different directions.

13. A method according to claim 12 with location of the annihilation occurring by means of a positron emission tomography detector.

14. A method according to claim 1, with a neutron source intensity being used in the range of 10⁸ to 10¹¹, preferably of 10¹⁰ neutrons/s.

15. A method according to claim 1, with location of the explosive being completed and evaluated by the information of an additional X-ray apparatus.

16. A method according to claim 1, with an explosive analysis being completed by a detection system based upon an ion mobility spectrometer.

17. A device for explosives' identification comprising :
a neutron source generating neutron energies which is greater or equal to the positron activation energy of nitrogen and greater or equal to the required energy for a neutron proton nuclear reaction of neutrons with ¹⁶O to ¹⁶N, and
a PET detector comprising a detector unit each on opposite sides of the sample.
